(19) United States
(12) Patent Application Publication
(10) Pub. No.: US 2015/0112874 A1
(43) Pub. Date: Apr. 23, 2015

(54) METHOD AND SYSTEM FOR PERFORMING OWNER ASSOCIATION ANALYTICS

(71) Applicant: CoreLogic Solutions, LLC, Irvine, CA (US)

(72) Inventors: Dianna SERIO, Irvine, CA (US); Darren TEETS, Irvine, CA (US); Susan ALLEN, Irvine, CA (US); Felice KESSELRING, Irvine, CA (US); Matthias BLUME, Irvine, CA (US)

(73) Assignee: CoreLogic Solutions, LLC, Irvine, CA (US)

(21) Appl. No.: 14/169,921

(22) Filed: Jan. 31, 2014

Related U.S. Application Data
(60) Provisional application No. 61/892,216, filed on Oct. 17, 2013.

(51) Int. Cl. G06Q 30/02; G06Q 50/16

(52) U.S. Cl. CPC G06Q 30/0278; G06Q 50/16
USPC 705/306

(57) ABSTRACT

Computer-based processes are disclosed for mining and analyzing owner association (OA) data associated with a plurality of real estate properties and generating an OA amount model that can be used to estimate OA amounts for a subject property. The OA data may also be analyzed to identify OA ratings, OA recommendations, OA delinquency actions, OA contacts information, OA services information, etc. The disclosed processes can also use the generated OA amount model to identify OA amount trends, and determine valuations and investment metrics for real estate properties.

### CROSS-REFERENCE TO RELATED APPLICATIONS

The present application claims the benefit of the earlier filing date of commonly owned U.S. Provisional Patent Application 61/892,216 filed on Oct. 17, 2013, the entire contents of which are hereby incorporated by reference in its entirety.

### BACKGROUND

1. Field

The present disclosure relates to computer processes for performing owner association (“OA”) analytics for a real estate property.

2. Description of the Related Art

According to 2012 national statistics provided by Community Association Institute, there are 25.9 million properties that are likely to be in 323,600 OAs in the United States. OAs include homeowners associations (“HOAs”), condominiums, co-operatives, and other planned communities. Lenders, investors, mortgage, and default servicers often have difficulty identifying whether a property is located in a community association. Delays in identifying and communicating with community associations can result in accrual fees and penalties that can represent losses to servicers, investors, and property owners. Further, balances owed to OAs may delay the sale of properties and result in increased carrying costs for investors and servicers. Moreover, in certain states OA liens are given “super lien” status and could trump lender liens and result in both monetary and collateral losses to institutions and lenders. Existing methods, studies, and analytical tools provide aggregation of OA data from multiple sources. However, focusing solely on the aggregated data may not provide an accurate picture of risks associated with OAs.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram that schematically illustrates an example of a system to perform OA analytics.

FIG. 2 is a block diagram that schematically illustrates an example of one or more modules that may be included in a system to generate an OA amount model.

FIG. 3 is a flowchart illustrating a method of building an OA amount model in accordance with an embodiment.

FIG. 4 is a flowchart that illustrates generating and using of an OA amount model in accordance with an embodiment.

FIG. 5 is a block diagram that schematically illustrates an example of one or more modules that may be included in a system to perform OA analytics.

FIG. 6 is a flowchart that illustrates an example of a method for determining a recommended OA amount in accordance with an embodiment.

FIG. 7 is a flowchart that illustrates an example of a method for determining a rating based on OA data in accordance with an embodiment.

FIG. 8 is a flowchart that illustrates an example of a method for determining a recommendation based on OA data in accordance with an embodiment.

FIG. 9 is a flowchart that illustrates an example of a method for determining a payment action for OA liens in accordance with an embodiment.

FIG. 10 is a flowchart that illustrates an example of a method for providing OA contacts information in accordance with an embodiment.

FIG. 11 is a flowchart that illustrates an example of a method for determining OA amount trends for real estate properties.

FIG. 12 is a flowchart illustrating an example of a method for determining valuations for real estate properties using an OA amount model.

FIG. 13 is a flowchart illustrating an example of a method for determining investment metrics for real estate properties using an OA amount model.

### DETAILED DESCRIPTION

Various aspects of the disclosure will now be described with regard to certain examples and embodiments, which are intended to illustrate but not to limit the disclosure.

Computer-based systems and methods are disclosed for performing OA analytics for real estate properties. In some embodiments, the systems and methods can improve predictions of fair market valuations by considering OA analytics in predicting valuations. In some embodiments, the systems and methods can improve determination of investment metrics by considering OA analytics in determining the investment metrics. In some embodiments, a confidence score and/or error rate, such as a forecast standard deviation (“FSD”) may be calculated to provide information about the relative error rate inherent in any market prediction.

### Overview

In some embodiments, an OA model (“OAM”) may be configured to automatically estimate an OA amount for a particular residential property or a group of residential properties. In addition, using the computerized models describe herein, lenders, mortgage servicers, or mortgage-backed security investors may make better disposition decisions for distressed properties. The company implementing such a model may sell the computerized model's prediction and report directly for example using a web interface, sell a decision support tool that utilizes the computerized model, and/or sell “OA Trends” tables of average OA amounts by geographic area and property type. In various embodiments, an OAM may be configured to enable estimating an OA rating for a particular property/OA or a group of properties/OAs and/or make OA recommendations. Complex statistical models, such as OAMs may be utilized to determine a rating for an OA/property or group of OAs/properties or make OA recommendations based on the large data set that has been collected. In some embodiments, OA liens on a subject property or group of properties may be analyzed to make a payment decision related to the OA liens. In various embodiments, the large OA data set may be analyzed to provide contacts and/or services information associated with OAs.

Implementations of the disclosed systems and methods will be described in the context of performing OA analytics for real estate properties. This is for purposes of illustration and is not a limitation. For example, implementations of the disclosed systems and methods can be used to perform OA analytics for commercial property developments such as office complexes, industrial or warehouse complexes, retail and shopping centers, and apartment rental complexes. In addition, although the determined OA analytics determined by various implementations of the systems and methods described herein can be used by OA models to provide automated valuations, the OA analytics can also be provided to and used by real estate brokers, real estate appraisers, and the like to perform manual valuations of a subject property.

### Example Real Estate OA Analytics System

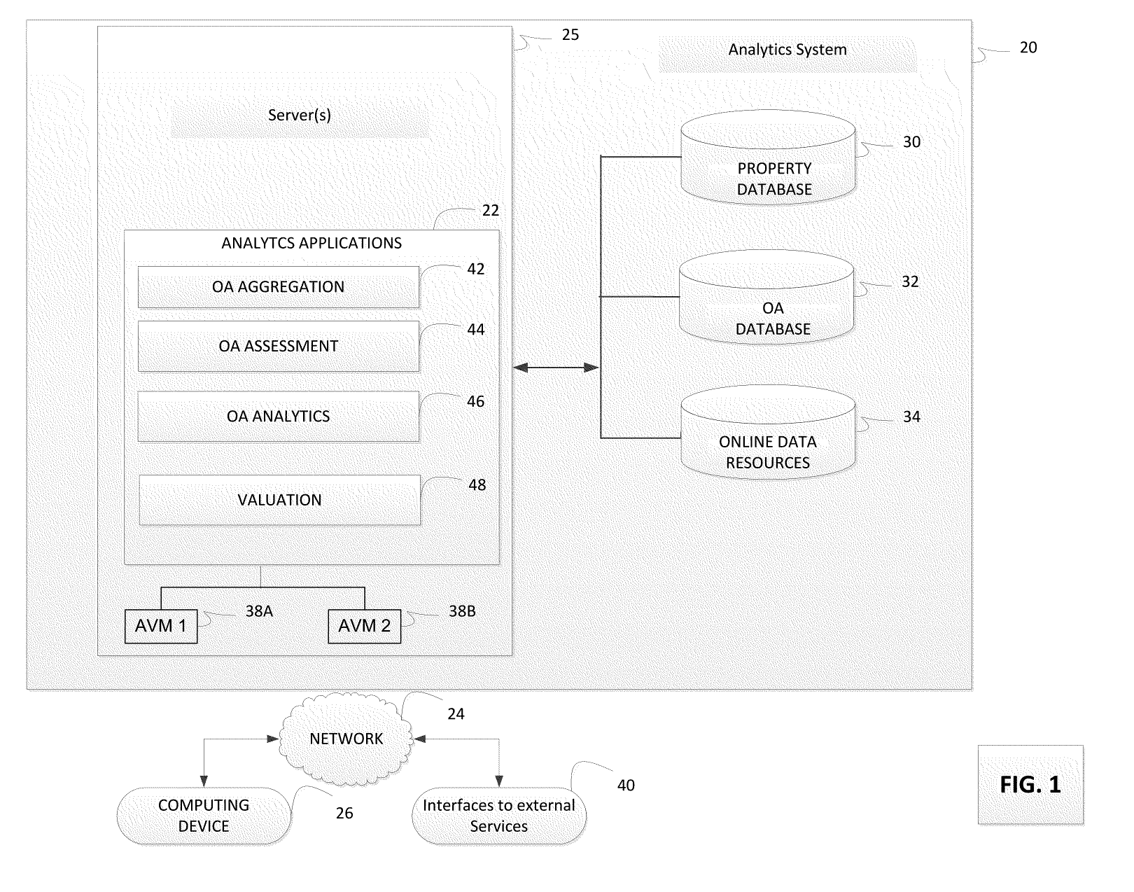

FIG. 1 illustrates an analytics system 20 according to one embodiment. The system may be provided by a business entity or “analytics provider” that provides various services to its customers for assessing investment opportunities and financial risks associated with real estate properties. As illustrated, the system includes a set of analytics applications 22 that are accessible over a network 24 (such as the Internet) via a computing device 26 (desktop computers, mobile phones, servers, etc.). Typical customers of the system 20 include mortgage lenders, other types of lenders, mortgage and default servicers, real estate investors, real estate brokers, and real estate appraisers.

As illustrated, analytics applications 22 use a set of data repositories 30-34 to perform various types of analytics tasks, including tasks associated with OA analytics. In the illustrated embodiment, these data repositories 30-34 include a database of property data 30, and database of OA data 32, and any other online data resources 34. Although depicted as separate databases, some of these data collections may be merged into a single database or distributed across multiple distinct databases. Further, additional databases containing other types of information may be maintained and used by the analytics applications 22. As shown in FIG. 1, each analytic application 22 runs on one or more physical servers 25 or other computing devices.

The property database 30 contains property data obtained from one or more of the entities that include property data associated with real estate properties. This data may include the type of property (single family home, condo, etc.), the sale price, and some characteristics that describe the property (beds, baths, square feet, etc.). These types of data sources can be found online. For example, multiple listing services (MLS) contain data intended for realtors, and can be contacted and queried through a network such as the Internet. Such data may then be downloaded for use by embodiments of the present invention. Other examples include retrieving data from databases/websites such as Redfin, Zillow, etc. that allow users to directly post about available properties. Furthermore, property database 30 may contain aggregated data collected from public records offices in various counties throughout the United States. This database 30 can include property ownership information and sales transaction histories with buyer and seller names, obtained from recorded land records (grant deeds, trust deeds, mortgages, other liens, etc.). In one embodiment, the analytics provider maintains this database 30 by purchasing or otherwise obtaining public record documents from most or all of the counties in the United States (from the respective public recorders offices), and by converting those documents (or data obtained from such documents) to a standard format. Such a database is maintained by CoreLogic, Inc. The property database 30 is preferably updated on a daily or near-daily basis so that it closely reflects the current ownership statuses of properties throughout the United States. In one implementation, the database 30 covers 97% of the sales transactions from over 2,535 counties.

The database 32 contains OA data obtained from one or more of the entities, such as OAs, appraisers, government, MLS, etc., that include OA data associated with real estate properties. This data can be any type of real estate data and may include the type of OA (HOA, condo, co-operative, etc.), the OA name, OA contact details, OA address, OA documents, OA dues, OA liens, cause of the OA liens (e.g., failure to pay OA dues, violation of OA regulation, etc.), OA services (financial, administrative, property management, etc.), OA services vendors, OA services vendor fees, OA services types, OA services vendors types, (gardening, swimming pool maintenance, construction, utilities, water, landscaping, street maintenance, janitorial, etc.), OA services vendors quality (rating, customer reviews, customer complaints, etc.), etc. Other examples of OA data sources may include retrieving data from databases/websites such as Redfin, Zillow, Yelp, etc. that allow users to directly post about OAs for real estate properties. OA data may also be retrieved from lien distress databases, such as public records databases or credit reporting databases maintained by credit reporting agencies. Examples of credit reporting agencies may include, Equifax, Experian, and Trans Union. In one embodiment, the analytics provider maintains this database 32 by purchasing or otherwise obtaining OA data from most or all of the OAs in the United States (from the respective OA offices), and by converting those documents (or data obtained from such documents) to a standard format. The OA database 32 is preferably updated on a daily or near-daily basis so that it closely reflects the OA statuses of properties throughout the United States.

Online data resources 34 include any other online resources that provide available OA data for real estate properties. Examples of online data resources 34 containing OA data include servers owned, operated, or affiliated with local governments, Sperlonga, CondoCerts, Alliant Property Management, or any other server or service containing OA data.

As further shown in FIG. 1, the system 20 may also include one or more interfaces 40 to other (externally hosted) services and databases. For example, the system may include APIs or other interfaces for retrieving data from LexisNexis, Merlin, MERS, particular real estate companies, government agencies, and other types of entities.

As further shown in FIG. 1, the analytics applications 22 include an “OA aggregation” application or application component 42 (hereinafter “application 42”). As explained below, this application or component 42 uses some or all of the data sources described above to acquire OA data from multiple entities.

The analytics applications 22 also include an “OA assessment” application or application component 44 (hereinafter “application 44”). As explained below, this application or component 44 is configured to generate an OA model that can be used to determine an OA amount or trend for real estate properties. Such OA information may be used for various risk-assessment-related or due diligence purposes. For example, real estate investors may use such information to determine investment prospects for a particular property. As another example, one or more of the analytics applications 22 may use an individual's property OA amount, together with other information regarding the individual property, to determine a valuation for the property. In some embodiments, multiple OAs may be associated with a particular real estate property. For these properties, multiple OA models may be generated and used to determine OA amounts or trends.

The analytics applications 22 also include an “OA analytics” application or application component 46 (hereinafter “application 46”). As explained below, this application or component 46 uses the OA model generated by application 44 to perform OA analytics for a particular property or group of properties.

The analytics applications 22 further include a “valuation” application or application component 48 (hereinafter “application 48”). As explained below application or component 48 can communicate with applications 42, 44, or 46, to determine a valuation, investment metric, etc. for the particular property or group of properties. For example, application 48 can communicate with AVM1 38A or AVM2 38B to determine an automated valuation for the particular property of group of properties.

### OA Aggregation

Application 42 may be configured to acquire OA data from multiple entities. Application 42 can be configured to aggregate OA data and store the aggregated data in OA database 32. For example, application 42 may review lien distress databases to determine all voluntary and involuntary liens associated with real estate properties. The liens may then be analyzed to determine which liens are associated with OAs. For liens associated with OAs, application 42 may determine OA detail information and store the OA information in the OA database 32 linked to the associated real estate properties. OA data may further be obtained by application 42 from respective OA offices. The OA data may be purchased from the OAs or obtained using any other business arrangement. OA data may additionally be collected from distressed properties databases, such as those provided by Real Capital Analytics, Inc., New Acre, etc. and consumers. OA data may also be collected from online data resources, such as MLS data, Redfin, Zillow, etc. Moreover, application 42 may determine that a group of real estate properties are associated with the same subdivision, census tract, zip code, county, condo, complex, etc. and determine that the same OA should be associated all real estate properties in the group. If application 42 can determine the OA details for one of the properties in the group, application 42 may associated the OA details with all the real estate properties in the group.

In some embodiments, the collected OA data can be analyzed for data anomalies or errors. For example, the “monthly OA fee” may have accidentally been provided as an annual OA fee, the decimal point may have been omitted, or a tax amount may have been inadvertently entered into the OA fee field. One possible way to identify erroneous values could be to establish a set of rules that may specify the realm of reasonable values and consider any value outside that range as erroneous. For example, any OA fee that exceeds $1000/month or 0.2% of the property value per month (whichever is more) may be dropped as erroneous. In one embodiment, for properties that include multiple OAs, similar analysis may apply by, for example, by only considering the largest OA fee.

### OA Assessment

Application 44 may be configured to generate one or more OA models that can be used to determine one or more OA amounts or trends for real estate properties. In some embodiments, the application 44 may communicate with application 42 and use one or more trained OAMs (discussed further below) to produce an OA amount. The outputs may be in the form of specific OA amounts, and/or in the form of OA amount ranges. For example, both $125 or $200-$300 are just examples of possible values for the OA amount output.

### OA Model Generation

As discussed, application 44 may be configured to generate one or more OA models that can be used to identify OA amounts/trends for real estate properties.

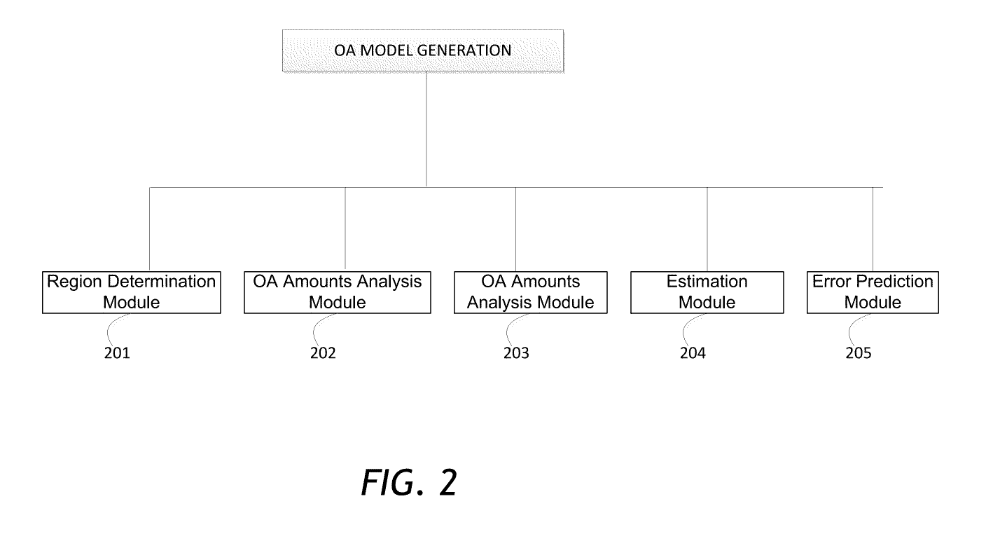

In one embodiment, application 44 may be configured to implement one or more software modules to generate the OA model that can be used to identify OA amounts/trends for real estate properties. For example, in some embodiments as shown in FIG. 2, the application 44 may be configured to implement a region determination module 201, an OA amounts analysis module 202, an OA amounts prediction module 203, an estimation module 204, and an error prediction module 205. Each of these example modules will be further explained.

For example, in some embodiments, the region determination module 201 determines a set of real estate properties that are part of the same group (e.g., OA or development). The purpose of identifying these regions is that OA fees generally have a characteristic that all of the properties within one OA tend to have a single value (fee), whereas properties outside that OA may have a very different value. This difference may exist even if the properties are similar in all other ways and comparable. That is, the value tends to be homogeneous for members of the OA and different for non-members. Therefore, to identify regions that may have homogeneous fees, the region determination module 201 determines a set of real estate properties that are part of the same group. To determine this, one or more attributes associated with the properties may be analyzed to determine which set of properties belong in the same group. This analysis may be performed multiple times to create multiple groups. Table 1 identifies a set of attributes that may be analyzed for each property to determine which set of properties belong to the same group.

TABLE 1
Factors for region determination

OA name
Subdivision name
Building permit
Street address
Zip code
Census tract
Year built
Roof type
Landscaping
Exterior
Living area
OA fees
OA liens

As illustrated in Table 1, if real estate properties have similar OA names, then they likely may be in the same group. If the properties have similar subdivision names, then the properties may be in the same group. If the properties had the same building permit for construction of the properties, then they may be in the same group. If the properties have similar street address excluding unit numbers, then they may be in the same group. If the properties have similar zip codes or census tracts, then they may in the same group. If the properties were built around the same time, have similar roof types, consistent landscaping, or exterior features (e.g., color scheme), then they may be in the same region. If the properties have similar living areas, OA fees, or OA liens from similar OAs, then they may be in the same group. In some embodiments, a combination of the listed factors may be considered in constructing the groups. In some embodiments, weights and/or priorities may be established for the factors to determine when the properties can be placed in the same group. For example, properties with different living areas may still be placed in the same group if they have similar landscaping and were constructed under the same building permit. As another example, even if properties have the same roof type they may not be placed in the same group. But if they also include one or more of the other factors, they may be placed in the same group based on one or more rules.

For example, in one embodiment, all properties that either share the same street address except unit number or share the same ZIP+4 are assigned to one group. This may assign each property to exactly one group. Pairs of groups then may be iteratively merged based on the attributes of properties in each group. Each merge can create one larger group and reduces the total number of groups by one.

As another example, in one embodiment, a set of rules may define which groups to merge. For instance, a rule may specify that groups can be merged if they are spatially adjacent or nearby and any properties in the groups share the same OA name or lien from the same OA. In some embodiments, it may be determined that two groups are adjacent or nearby if the first seven digits of the ZIP+4 of the two groups are the same, if the distance between the centroids of the two groups is below a certain threshold, or if polygons defining the two groups are adjacent. As another example, if two nearby groups of properties have consistent OA fees, the groups can be merged. Consistent fees, in some embodiments, can be defined as knowing at least one OA fee for both groups, knowing that the OA fees in each group are homogenous, and that the at least one OA fee for each group is the same. Another example could include if two groups are nearby and OA fees are not known for any of the properties in one of the two groups but the groups are consistent in year built and living area, the two groups may be merged. As yet another example, if Group A consists of two or more discontiguous parts and part of Group B is between two parts of Group A, Group A may either be split into two or more separate groups, or Group B may be merged into Group A. In some embodiments, between may be defined based on the street address, taking into consideration that odd and even street numbers are normally on opposite sides of the street. For example, 123 Elm St. may assumed to be between 83 Elm St. and 163 Elm St. However, if the property attributes in Group B are inconsistent with the property attributes in Group A, Group A may be split. On the other hand, if the property attributes are missing in Group B or in Group A, Group B can merged into Group A. A variety of different rules and conditions may be implemented by embodiments of the present inventions. For example, the order of the above operations may be changed, yielding similar but different results.

In some embodiments, to reduce the overall computation time and data storage requirements, any ZIP+4 that contains exactly one property and no OA indication (fee or OA name) may be excluded from the merge process. This property may be excluded from the merge process because these properties typically do not belong to an OA. In an alternative embodiment, a statistical model may be trained to determine in which instances two groups should be merged. The order in which pairs of groups are selected for possibly being merge based on the score of the model can still be rule-based.

### OA Amounts Analysis

The OA amounts analysis module 202 determines whether the groups generated above are associated with an OA and determines the OA fees if the regions are associated with an OA. To first determine if a generated group is associated with an OA, in one embodiment, it can be determined whether an OA fee or an OA lien is listed for any of the properties in the group. If an OA fee or OA lien is found for at least one property in the group, it can be assumed that the group of properties has an OA. Alternatively, in some embodiments, if it is determined that OA fees or OA liens are listed for greater than 2% of the properties in the group, it can be assumed that the group of properties has an OA. A variety of different rules and configurations are possible in embodiments of the present invention.

In some embodiments, additional rules or a statistical model may be used to infer whether an OA is present. For example, property characteristics of the properties in the groups may be analyzed to infer whether an OA is present. Characteristics of properties that can be predictive include whether the property neighborhood or complex has a pool, whether the property neighborhood or complex has a gym, whether the property neighborhood or complex has a golf course, whether the property neighborhood or complex is a “gated community”, the year that the property or complex was built, whether the property is located in urban or suburban area, the number of floors in the property or complex, fraction of neighborhoods or complexes with OAs in the region of the property, type of units in the property neighborhood or complex (single-family detached houses, townhouses, high-rise condominiums, condominiums in two-story buildings), fraction of owner-occupied versus rental units in the property neighborhood or complex.

For the groups that are found to be associated with an OA, the OA amounts prediction module 203 then may access OA data from the OA database 32 to determine OA amounts for properties. For the identified groups, if the OA database 32 contains OA data for at least one of the properties in a group, similar OA data can be inferred for all properties in the group and stored in OA database 32 for each of the properties in the group. However, if prediction module 203 determines from accessing OA database 32 that multiple properties in the group are listed with different OA fees and the different fees are inconsistent with a one-time increase or decrease in fees for all properties, then it may be determined that the fee is not the same for all properties in the OA, and a simple inference cannot be made for the properties for which OA data does not exist. To determine whether the fees are associated with a one-time increase or decrease, changes in the fees can be detected over time and the point in time at which an OA fee changed for a particular group may be accomplished by measuring changes in the histogram of OA fees with a sliding time window. For example, a single number representation of the histogram that can be useful for detecting change may be the mode (e.g., most common OA fee value) within the time window. With a large enough time window, a change in the mode may be a good indication that the fee changed. Subsequently it can be determined whether the different OA fees in the group are consistent with the detected changes in fees and used to infer fees for other properties in the groups or whether they are inconsistent and inferences cannot be made. Those skilled in the art will appreciate that other metrics may be used in embodiments of the present invention.

One possible way to still make an inference, if not possible based on the rules discussed above, is by testing the OA fees in the group against one or more test conditions to determine if an OA fee pattern can be detected. For example, one test condition could assume that the OA fee is constant for each number of bedrooms (e.g. 1, 2). Then the OA fees existing in the OA database 32 could be analyzed to determine whether this condition is satisfied. If the condition is satisfied, then an inference can be made for OAs fees for all properties in the group based on their respective number of bedrooms. If the condition is not satisfied, additional test conditions could be evaluated. As another example, a test condition could assume that the fee is constant for each floor of the building (and increases monotonically with floor number and the fee is higher for more valuable properties). Then the OA fees existing in the OA database 32 could be analyzed to determine whether this condition is satisfied. If the condition is satisfied, then an inference can be made for OA fees for all properties in the group based on their respective number of floors. If this condition is not satisfied, similar test conditions and rules could be considered to detect if any OA fees patterns exist for the group being considered.

### OA Estimation

The estimation module 204 estimates OA fees by using one or more predictive models for groups that were determined to be associated with an OA but for which an OA fee for at least one of the properties could not be identified or for which inferences could not be made for all the properties for the reasons discussed above. The determined estimates then may be stored in the OA database 32 linked to its respective property.

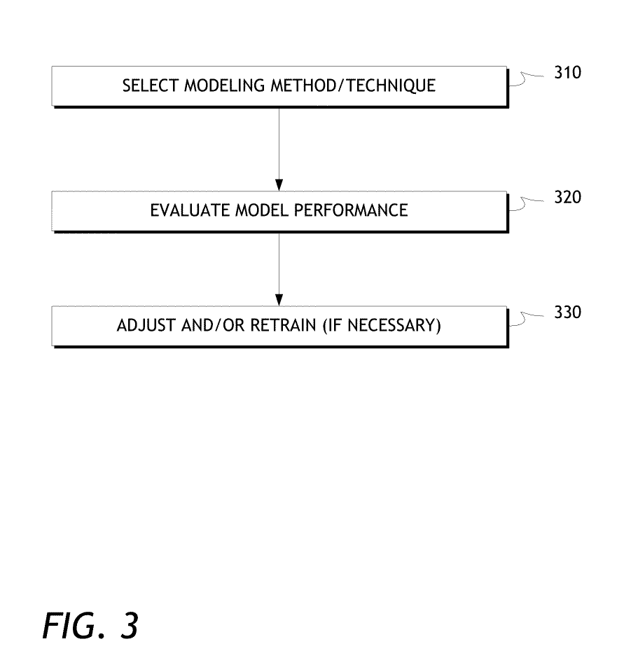

As depicted in FIG. 3, generating an OA estimation model includes selecting modeling method(s)/technique(s) (block 310). Example modeling techniques may include but are not limited to linear regression, logistic regression, neural networks, support vector machines, decision trees, and their derivatives. Suitable modeling methods may include machine learning/data mining techniques including linear regression, logistic regression, neural networks, support vector machine, decision tree, etc. A further modeling technique is a comparables model where the rules and weights for computing an estimate based on a set of comparable OAs can be chosen by a human expert. In this technique, it may be possible to use regression on-the-fly to automatically learn a new set of weights for each subject OA or property based on the characteristics of comparable OAs or properties for that subject OA or property. In practice, one technique can be used in the research effort to provide insights for another modeling technique. Thus a combination of techniques can be used in the analysis and in the product implementation.

As discussed above, suitable modeling methods include linear regression and/or logistic regression. Linear regression is a widely used statistical method that can be used to predict a target variable using a linear combination of multiple input variables. Logistic regression is a generalized linear model applied to classification problems. It predicts log odds of a target event occurring using a linear combination of multiple input variables. These linear methods have the advantage of robustness and low computational complexity. These methods are also widely used to classify non-linear problems by encoding the nonlinearity into the input features. Although the mapping from the feature space to the output space is linear, the overall mapping from input variables through features to output is nonlinear and thus such techniques are able to classify the complex nonlinear boundaries. Desirably, the linear mapping between the feature space and the output space may make the final score easy to interpret for the end users.

Another suitable modeling method is neural networks. Logistic regression generally needs careful coding of feature values especially when complex nonlinear problems are involved. Such encoding needs good domain knowledge and in many cases involves trial-and-error efforts that could be time-consuming. A neural network has such nonlinearity classification/regression embedded in the network itself and can theoretically achieve universal approximation, meaning that it can classify any degree of complex problems if there is no limit on the size of the network. However, neural networks are more vulnerable to noise and it may be more difficult for the end users to interpret the results. In one embodiment, one suitable neural network structure is the feed-forward, back-prop, 1 hidden layer version. Neural networks may provide more robust models to be used in production environments when based on a larger data set than would be need to provide robust models from logistic regression. Also, the number of hidden nodes in the single hidden layer is important: too many nodes and the network will memorize the details of the specific training set and not be able to generalize to new data; too few nodes and the network will not be able to learn the training patterns very well and may not be able to perform adequately. Neural networks are often considered to be “black boxes” because of their intrinsic non-linearity.

Embodiments may also include models that are based on support vector machines (SVMs). A SVM is a maximum margin classifier that involves solving a quadratic programming problem in the dual space. Since the margin is maximized, it will usually lead to low generalization error. One of the desirable features of SVMs is that such a model can cure the “curse of dimensionality” by implicit mapping of the input vectors into high-dimensional vectors through the use of kernel functions in the input space. A SVM can be a linear classifier to solve the nonlinear problem. Since all the nonlinear boundaries in the input space can be linear boundaries in the high-dimensional functional space, a linear classification in the functional space provides the nonlinear classification in the input space. It is to be recognized that such models may require very large volume of independent data when the input dimension is high.

Embodiments may also include models that are based on decision trees. Decision trees are generated using a machine learning algorithm that uses a tree-like graph to predict an outcome. Learning is accomplished by partitioning the source set into subsets using an attribute value in a recursive manner. This recursive partitioning is finished when pre-selected stopping criteria are met. A decision tree is initially designed to solve classification problems using categorical variables. It can also be extended to solve regression problem as well using regression trees. The Classification and Regression Tree (CART) methodology is one suitable approach to decision tree modeling. Depending on the tree structure, the compromise between granular classification, (which may have extremely good detection performance) and generalization, presents a challenge for the decision tree. Like logistic regression, results from decisions trees are easy to interpret for the end users.

Once the modeling method is determined, the OA estimation model is trained based on the historical data adaptively. The parameters of the model “learn” or automatically adjust to the patterns in the historical data and then generalize these patterns for detection purposes. When new OA data is detected, the model will evaluate its fees based on what it has learned in its training history. The modeling techniques for generating the OA estimation may be adjusted in the training process recursively.

The listing of modeling techniques provided herein are not exhaustive. Those skilled in art will appreciate that other predictive modeling techniques may be used in various embodiments. Example predictive modeling techniques may include Genetic Algorithms, Hidden Markov Models, Self Organizing Maps, Dynamic Bayesian Networks, Fuzzy Logic, and Time Series Analysis. In addition, in one embodiment, a combination of the aforementioned modeling techniques and other suitable modeling techniques may be used in the OA estimation model.

As depicted in block 320 of FIG. 3, the performance of the OA estimation model may be evaluated in its predictive power and generalization prior to release to production. For example, in one embodiment the performance of an OA estimation model is evaluated on both the training dataset and the testing dataset, where the testing dataset is not used during the model development. The difference between the performance in the training data and the testing data demonstrates how robust the model is and how much the model is able to generalize to other datasets. The closer the two performances are, the more robust the model is.

Finally, at a block 330, the OA estimation model may be adjusted and/or retrained as needed. For example, the OA estimation model may be adjusted to use a different modeling technique, based on the evaluation of the model performance. The adjusted OA estimation model may then be re-trained. In another example, the OA estimation model may be re-trained using updated and/or expanded data (e.g., OA data) as they become available.

The outputs of the OA estimation model may be collected by application 44 to identify any OA fee trends. The application 44 may collect outputs from the generated OA estimation model at periodic intervals to identify OA fee trends. The identified outputs and/or trends may be stored or provided to interested parties, such as the computing device 26.

In one embodiment, the estimation module 204 may use a nonlinear regression model trained using a gradient descent boosting tree algorithm. Gradient boosting is a machine learning algorithm that is useful for solving regression problems. It produces a prediction model in the form of a collection of weak prediction models, such as decision trees. The algorithm builds the model in stages, and generalizes each stage by allowing optimization of a differentiable loss function. The method tries to, in each stage, find an approximation that minimizes the average value of the loss function on a training set of data. It does so by starting the model with a constant function, and incrementally expanding the model in a greedy fashion.

Such an algorithm may be represented by the equation:

P=F₀+B₁*T₁(X)+B₂*T₂(X)+ . . . +Bₙ*Tₙ(X)

where P is the predicted OA fee for a subject property, F₀ is the starting value for the series (i.e. mean target value for a regression model), X is a vector containing variables used in the model, T₁(X), T₂(X) . . . Tₙ(X) are small trees fitted to the pseudo-residuals at each stage and B₁, B₂ . . . Bₙ etc. are coefficients of the tree node predicted values.

A gradient descent boosting tree algorithm can be configured with a number of parameters, including the number of trees to use, the learning rate, the number of nodes per tree, the minimum children for each tree, and which loss function to use. In some embodiments, these parameters may be configured as: number of trees=2000, learning rate=0.05, number of terminal nodes=8, minimum children for each tree=200, loss function=least absolute deviation.

The estimation module 204 may optimize its model based on various kinds of variables, including (1) property variables, (2) property neighborhood or complex variables, and (3) variables that represent aspects of comparable properties or OAs.

The boosting tree algorithm selects these variables based on error reduction from a cut on given variables. The most important variable gives the largest error reduction in regression to the target value, and selection progresses in a greedy fashion. The algorithm iterates through each of the feature subsets, and measures the predictive performance of that subset by the amount of prediction error it reduces through an optimal splitting point. It picks the feature that gives the largest error reduction. This process, called training the model, is repeated until the number of nodes reaches the maximum number given by the user or the error measurement (loss function) converges. In this manner, the gradient boosting decision tree algorithm builds a series of small decision trees sequentially based on the variables calculated for all the properties being used as training properties. The next tree is based on the residual of the existing trees. The importance of each variable is based on the overall contribution to error reduction across all decision trees.

The variables, also known as feature characteristics, described above may be derived and stored. These variables may be calculated specifically for a certain property, or may be useful to define OA fees that are associated with one or more groups or OAs. For example, feature characteristics may be calculated on a group basis, where the feature characteristics comprise average OA fees summarized over characteristics of properties (e.g., number of floors, year built,), number of bedrooms, number of bathrooms, etc.). Below is a list of example variables, derived or raw, that may be used in some embodiments, calculated over each property or group (for model creation and training purposes), or for each subject property or group (for use when the model is used for predictions):

Weighted average OA fee by property neighborhood or complex having a
swimming pool and property type in the previous year for property
zip code (zip level 5)
Weighted average OA fee by number of beds and property type in the
previous year for property zip code (zip level 5)
Weighted average OA fee by number of baths and property type in the
previous year for property zip code (zip level 5)
Year property was built
Number of bed rooms
Number of bath rooms
Weighted average OA fee by property neighborhood or complex having a
gated community and property type in the previous year for property
zip code (zip level 5)
Weighted average OA fee by property neighborhood or complex having a
gym and property type in the previous year for property zip code
(zip level 5)
Weighted average OA fee by property neighborhood or complex having a
golf course and property type in the previous year for property
zip code (zip level 5)
Weighted average OA fee by property neighborhood or complex having a
park and property type in the previous year for property zip code
(zip level 5)
Weighted average OA fee by amount of property neighborhood or
complex green space and property type in the previous year for
property zip code (zip level 5)
Weighted average OA fee by urban property neighborhood or complex and
property type in the previous year for property zip code (zip level 5)
Weighted average OA fee by suburban property neighborhood or complex
and property type in the previous year for property zip code
(zip level 5)
Median monthly income in the previous year for the property's
zip code (zip level 5)
Median property value in the previous year for the property's
zip code (zip level 5)
Median vacancy rate in the previous year for the property's
zip code (zip level 5)
Median foreclosure rate in the previous year for the property's
zip code (zip level 5)
Median OA fee in the previous year for the property's zip code
(zip level 5)
Median sales price for the zip code of a property at a given year and
quarter (zip level 5)
Weighted average OA fee by distance from property neighborhood or
complex to points of interest (e.g., ocean, railroad track,
office complex, etc.) and property type in the previous year
for property zip code (zip level 5)
Weighted average OA fee by OA type for property zip code (zip level 5)
Weighted average OA fee by number of properties in an OA in the
previous year for property zip code (zip level 5)
Weighted average OA fee by number of properties managed by OA in the
previous year for property zip code (zip level 5)
Weighted average OA fee by average number of services provided by OA
in the previous year for property zip code (zip level 5)
Weighted average OA fee by average fees paid for services provided by
OA in the previous year for property zip code (zip level 5)
Total OA count divided by total property count in the previous year for
property zip code (zip level 5)
Weighted average OA count by property type for property zip code (zip
level 5)

For those data points that are associated with a property by its location (e.g., an median vacancy rates for specific properties in a zip code) and not per se specific to a particular property, those may all be pre-generated and placed in a table or other data structure organized by zip code, OA type, property type category, etc.

The above list of information used as variables in the model are only representative and other combinations of data may be used, including any of the data source mentioned previously. This includes summaries of geographic information including employment data and trends (such as employment rate in an area and the types of large employers in the area), educational level, reputation of K-12 school systems, the ratio of apartments to single family homes, etc.

Once the required variables have been calculated for all properties or groups in the database, the model may be trained by applying the gradient tree boosting algorithm to these properties or groups and their associated variables described above. For example, in embodiments where the maximum number of specified trees is 2000 each having 8 nodes, the final model will consisted of 2000 small regression trees, where each tree (T(X)) has 8 nodes. In other words,

P=F₀+B₁*T₁(X)+B₂*T₂(X)+ . . . +B₂₀₀₀*T₂₀₀₀(X)

Not all of the properties or groups in data repositories 30-34 are needed to create the model. One way to test is to set aside a small percentage of the properties or groups, for example 25%, to use as test properties or groups instead of training properties or groups. These properties or groups may then be treated as subject properties or groups, where the model will predict an OA fee using the subject properties or groups derived variables/characteristics. Because these properties or groups also have known OA fees associated with them, the model can be validated based on the differences between the predicted OA fees for these properties, and the known OA fees for these properties. The following error rates (discussed further below) may be calculated, such as mean of errors, absolute errors, percent of estimate with error less than +/−10%, percent of estimate with error less than +/−20%, and error in absolute form. By determining these error rates for specific geographic regions, when a subject property or group's OA fee is predicted, a confidence score may be associated with the prediction based on the error rate of the subject property's geographic location or property type.

### Error Module

The Error Prediction Module 205 is a module that may be used to estimate/predict errors of the analytics applications 22. One measurement of error for a prediction model is the Forecast Standard Deviation (FSD). FSD is a statistical measure that represents the probability that the estimated value produced by the analytics applications 22 falls within a particular range of the actual OA amount. For example, if the FSD for a model estimate is 10%, there is a 68% (one standard deviation) probability that the true OA amount will fall between +/−10% of the prediction.

The Error Prediction Module 205 may use a similar method as the Estimation Module 204 to calculate an error value. For example, in some embodiments, the Error Prediction Module 205 may execute a nonlinear regression model using gradient boosting decision tree approach by minimizing a loss function. Instead of the OA amount as the “predicted” dependent variable, the “predicted” dependent variable is the absolute value of the percentage error of the analytics application's estimate versus the actual value of the OA amount. The Error Prediction Module 205 may take the predicted OA amount plus other property-level variables as independent variables, and uses the properties or groups (and their derived variables/characteristics) as training properties. This can be generalized by the equation:

E=F₀+B₁*T₁(X)+B₂*T₂(X)+ . . . +Bₙ*Tₙ(X)

where E is the absolute value of the percentage error of the Analytics Application's estimate versus the future actual value of the OA amount for a subject property or group, F₀ is the starting value for the series (e.g., mean target value for a regression model), X is a vector of independent variables used in this model, T₁(X), T₂(X) . . . Tₙ(X) are small trees fitted to the pseudo-residuals at each stage and B₁, B₂ . . . Bₙ etc. are coefficients of the tree node predicted values.

Because the error in OA amount prediction by the application 44 may be due to a variety of factors, different sets of variables/characteristics may be calculated to characterize the potential reasons of discrepancy between the predicted OA amount and the true OA amount. These variables may include information from the following categories: (1) ZIP-level summary variables, (2) OA amount estimated from the OA model, (3) property characteristics, (4) OA attributes, (5) variables representing data availability and missing values entering into the OA model. Examples of these variables are listed below:

Minimum of percentage deviation of predicted OA amount from true
OA amount in the same ZIP code as property.
25 percentile of percentage deviation of predicted OA amount from true
OA amount in the same ZIP code as property.
Median of percentage deviation of predicted OA amount from true
OA amount in the same ZIP code as property.
Mean of percentage deviation of predicted OA amount from true
OA amount in the same ZIP code as property.
75 percentile of percentage deviation of predicted OA amount from true
OA amount in the same ZIP code as property
Maximum of percentage deviation of predicted OA amount from true
OA amount in the same ZIP code as property
Listing count in same ZIP code as property
Minimum of number of bed rooms in the same ZIP code as property
25 percentile of number of bed rooms in the same ZIP code as property
Median of number of bed rooms in the same ZIP code as property
Mean of number of bed rooms in the same ZIP code as property
75 percentile of number of bed rooms in the same ZIP code as property
Maximum of number of bed rooms in the same ZIP code as property
AVM of the property (weighted average of all AVM models)
Predicted OA amount from Estimation Module
Property Type (condo, single family house, etc.)
Year built
Number of bed rooms
Number of floors
OA Type (HOA, condo, co-operative)
OA size
Number of OA services
Type of OA services
Fees paid for OA services
Number of comparable OAs found

Once the required variables have been calculated for all properties or groups, the model may be trained by applying the gradient tree boosting algorithm to these properties or groups and their associated error variables described above. For example, in embodiments where the maximum number of specified trees is 1999 each having at least 50 nodes, and the loss function is the absolute error, the final model will consist of 1999 small regression trees, where each tree (T(X)) has at least 50 nodes. In other words,

E=F₀+B₁*T₁(X)+B₂*T₂(X)+ . . . +B₁₉₉₉*T₁₉₉₉(X)

Once trained, the Error Prediction Module 205 may be tested. Not all of the properties or groups in data repositories 30-34 are needed to create the model used by the Error Prediction Module 205. One way to test is to set aside a small percentage of the properties or group, for example 25%, to use as test properties or groups instead of model training properties. These properties or groups may then be treated as subject properties or groups, where the model will predict, by executing the equation above, an absolute value of the percentage error for each property or group. Because these properties or groups may also have known OA amounts and predictions associated with them, the model can be validated based on the known error of the prediction. For example, the model may be tested by calculating the true absolute value of the percentage error for all records in the test set having the same predicted absolute value of the percentage error. Then, the predicted and the true absolute value of the percentage error for each bin can be compared to determine the model's accuracy. Using this comparison, the following error rates may be calculated, such as mean of errors, absolute errors, percent of estimate with error less than +/−10%, percent of estimate with error less than +/−20%, and error in absolute form.

After training and optional testing of the model, the model may be executed to predict error. When the model executes, it first predicts the error of each OA amount estimate for each subject property or group. Once this step is done, the FSD may be calculated based on each percentile of the predicted error. A linear relationship between predicted error and the FSD may then be calculated by linear regression.

Based on the error model, a confidence score may be calculated. This confidence score may have a linear or non-linear relationship to the FSD value, and may indicate, for example, on a scale of 1-100 the confidence level of the OA amount prediction. The confidence score may be a translation or mapping of FSD values to preconfigured scale. For example, in some embodiments, the system may be configured so that an FSD between 0 and 0.1 may be considered a “high” confidence score, an FSD higher than 0.1 and less than or equal to 0.3 may be a “medium” confidence score, and an FSD above 0.3 may be mapped to a “low” confidence score. In some embodiments, instead of “high”, “medium”, and “low” confidence scores, a mapping using ABCDF, such as the traditional grading scale, may be used, among other similar grading mappings. One advantage of using a mapped confidence score rather than an FSD value is that it may be more easily understood by a consumer or investor using the system.

### Example OA Amount Estimation Process

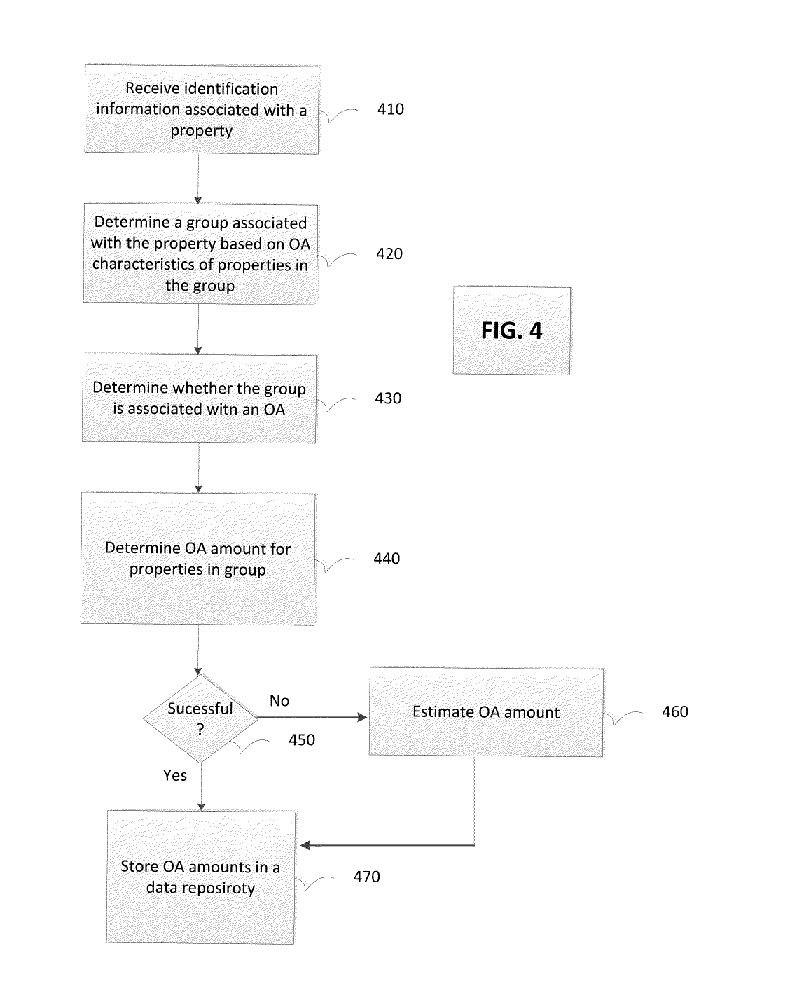

FIG. 4 illustrates one embodiment of an automated process that may be used by the analytics applications 22 to determine an OA amount for a subject property or group as discussed above.

As depicted by block 410 of FIG. 4, the application 46 initially receives identification information associated with a property (e.g., address, property owner identification, parcel number, etc.). Application 46 may communicate with computing device 26 to receive the identification information. The application 46 may then, in some embodiments, process the received identification information to uniquely identify the subject property of interest by, for example, communicating with data repositories 30-34 or any other data repository to map the received identification information to the subject property.

As shown in block 420 of FIG. 4, a group associated with the identified property is determined. As explained above, the application 44 may determine a group that is likely to have homogenous OA fees and includes the identified property. The grouping can be determined by consideration of a variety of factors and conditions as discussed above. The groups may also be merged as discussed above by the consideration of one or more rules.

As depicted by blocks 430 of FIG. 4, a determination is then made whether the identified group is associated with an OA. As discussed above, a variety of factors, including fees for properties of the group may be considered in making the determination.

As depicted by block 440 of FIG. 4, application 44 may determine OA amounts for the properties in the identified group. As discussed above, any assessed fees for properties in the groups may be analyzed to determine whether the fees may be inferred for other properties in the group. Also the collected fees may be analyzed to detect any patterns that may be used to infer fees for other properties.

As depicted by block 450 of FIG. 4, if the determination of the fees for the properties in the group was successful, then the determined OA fees may be stored in a data repository (block 470). However, if the OA fees could not be successfully determined for the properties in the group, then OA amounts for those properties may be determined using one or more predictive models as discussed above (block 460). Error estimations may also be made regarding those predictions as also discussed above.

### OA Analytics

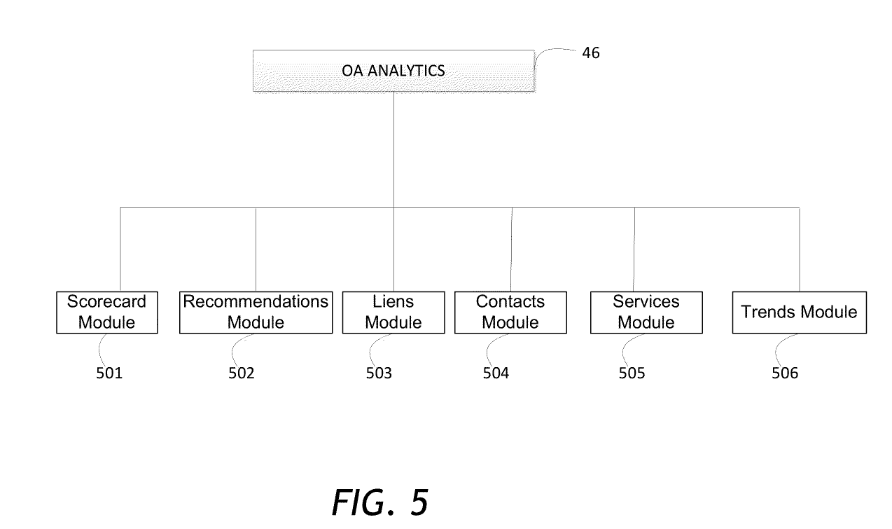

Application 46 may be configured to perform OA analytics for a particular property or group of properties. In one embodiment, application 46 may be configured to implement one or more software modules to perform OA analytics for a particular property or group of properties. For example, in some embodiments as shown in FIG. 5, the application 46 may be configured to implement a scorecard module 501, a recommendations module 502, a liens module 503, a contacts module 504, a services module 505, and a trends module 506. Each of these example modules will be further explained.

For example, in some embodiments, the scorecard module 501 is configured to determine a rating/ranking for a particular property or a group of properties and/or for a particular OA or group of OAs. The ranking/rating can be used by interested parties, such as OAs, investors, financial institutions, etc. to determine how the OA amount for a particular property/OA or group of properties/OAs compare to OA amounts for other properties/OAs. For instance, scorecard module 501 may communicate with application 42 and application 44 to determine an predicted OA amount for the particular property to be ranked or rated. The scorecard module 501 then may compare the actual or inferred OA amount with the predicted OA amount to determine a ranking/rating for the particular property. Since the predicted OA amount, as discussed above, can be based on comparisons to the OA amounts associated with other similar properties, a ranking/rating associated with the actual or inferred OA amount for the particular property of interest may be determined. Similarly, a rating/ranking for a particular OA can be determined by the scorecard module 501 by communicating with application 42 and application 44 to determine a predicted OA amount for each property managed by the OA of interest and compare the predicted OA amounts for each property with the actual or inferred OA amounts for each property. The comparisons may then be combined to determine a ranking/rating for the OA of interest. The comparisons may be combined using any of the processes discussed above. In some embodiments, the error models discussed above may also be used to determine the rankings/ratings. In some embodiments, a rating/ranking for a particular OA can be determined by the scorecard module 501 by considering a variety of other factors. For example, the ratings/rankings may be based on number of services/amenities provided by the OA in comparison to other OAs, OA amounts charged by the OA in combination with the number of services/amenities in comparison to other OAs, quality of services/amenities providers used by the OA in comparison to other OAs, reviews of the OA in comparison to other OAs, type of services/amenities provided by the OA in comparison to others OAs, fees paid for services/amenities by the OA in comparison to others, etc. A combination of these factors among others may be considered in determination of the rankings/ratings by the scorecard module 501 using the processes discussed above.

In some embodiments, the rankings/ratings may be determined based on user preferences. For example, a user preference may indicate that a particular property be ranked/rated against properties in the same zip code that have the same number of services provided by the respective OAs. The scorecard module 501 may then communicate the user preferences to application 42 and application 44 to determine the predicted OA amount based on the preferences. Similar processing may be performed for ranking/rating OAs based on user preferences. For example, a user preference may include an indication that the particular OA of interest only be compared to OAs in the same city that manages the same number of properties. The user preferences then may be communicated to application 42 and application 44 to determine the predicted OA amounts, as discussed above. Embodiments of the present invention are not limited to example rankings/ratings discussed above. A variety of other rankings/ratings could be determined by the scorecard module 501 in embodiments of the present invention. For example, the scorecard module 501 may determine a ranking/rating for a particular property or OA by comparison to an aggregate OA amounts in a region associated with the particular property or OA. As an example, the ranking/rating of a property could be determined by comparison to the mean OA amount in the state associated the particular property of interest. As another example, a rating/ranking for an OA may be based on a comparison of number/type of services provided by the OA compared to the number/type of comparable OAs.

Next, in some embodiments, the recommendations module 502 is configured to provide a recommendation for an OA amount and/or OA information for a property or group of properties or for an OA or group of OAs. The recommendation can be used by interested parties, such as OAs, to determine how much fees should be charged by the OA. For instance, an OA managing a new development may request the recommendations module 502 for a recommendation on what OA fees should be charged. The OA may provide property characteristics of properties in the new development, OA attributes, location characteristics, timing characteristics, etc. to the recommendations module 502. The recommendations module 502 may then communicate the received information to the application 42 and application 44 to determine a predicted OA amount for the properties in the new development. The predicted OA amounts may then be provided to the requesting OA in any desired format. For example, recommendations module 502 may provide the recommended OA amounts based on property types. In some embodiments, the recommendations module 502 may be provided a desired OA amount for a property or group of properties or for an OA or group of OAs from interested parties. The recommendations module 502 may then communicate with application 42 and 44 to determine the number/type of services that are being provided by OAs with comparable OA amounts and/or determine property characteristics of properties managed by OAs with comparable OA amounts and provide the identified information to the interested parties. As another example, the recommendations module 502 may be provided a desired vendors services fees amount for a property or group of properties or for an OA or group of OAs. The recommendations module 502 may then communicate with application 42 and 44 to determine a list of recommended vendors based on the desired fees amount that are comparable to the property or group of properties or the OA or group of OAs, and provide the identified information to the interested parties. As yet another example, an OA may provide the recommendations module 502 property characteristics of properties being managed by the OA and a desired return on investment. The recommendations module 502 then may communicate with application 42 and 44 to identify vendors' fees for comparable OAs and to determine a recommended OA amount based on the identified information and desired return on investment. The determined information may then be provided to interested parties.

The liens module 503, in some embodiments, is configured to identify any OA liens associated with properties and may determine an action associated with any identified liens. The liens module 503 can determine a priority associated with any identified OA liens and make a determination of the action based on the determined priority. For example, the liens module 503 may determine that a property associated with the identified liens is in a super lien state and may make a determination of whether to pay off the identified liens. The determination of an action based on the determined priority can be based on one or more criteria. In an embodiment, criteria for whether to perform an action may vary depending on the state in which the property associated with any identified liens resides. Predetermined criteria for processing a delinquency item (e.g., capturing a redemption amount or initiating OA payment) may be embodied in a set of business rules. In some embodiments, the business rules produce a different result depending on the state in which the lien exists. In one embodiment, each delinquent item is assessed against a “state matrix” in which a threshold date is defined for each state or OA. The threshold time to act may be shorter for OAs that act more aggressively on delinquent OA liens, and longer for OAs that act less aggressively on delinquent OA liens. In some embodiments, the threshold time is a particular calendar year. A delinquency date of the delinquency item may be tested against threshold date for the state in which the property resides.

In some embodiments, an equity analysis may be performed on the item if the state criteria for processing the delinquency item are met. The equity analysis may include calculating an equity amount of the property and comparing the equity amount to a loan amount for the property. If the equity amount meets predetermined criteria relative to the loan amount, a process (e.g., preparing a redemption report, initiating a payment request) may be performed for the delinquency item. As used herein, “redemption” or “redeem” refers to any act to redeem a property after an OA delinquency or to correct, cure, or reverse an OA delinquency condition. As used herein, “redemption reporting” refers to determining redemption information and/or outputting the redemption information for reporting, review, or further action or processing. Determining redemption information may include acquiring information from external or internal systems (e.g., OA systems, lender systems, servicer systems), applying business rules, performing computations, or a combination thereof. Redemption information may include redemption amounts. As used herein, a “redemption amount” refers to an amount of payment required to redeem a property. Redemption amounts may include past due OA amounts, interest, costs, penalties, and other charges.

In certain embodiments, the criteria are customizable for two or more lenders or servicers. For example, one lender may specify the use of a broker price method for performing an equity analysis, while another lender may specify the use of an automated value model. In some embodiments, lenders or servicers may opt in or opt out of particular processing actions. For example, while one lender may choose to perform an equity analysis if an OA criticality test is met, another lender may choose to forego equity analysis and go immediately to a redemption search if an OA criticality test is met. In some embodiments, lender preferences are submitted in writing or electronically to a service provider and the service provider enters the preferences into a lien service system. In other embodiments, a lender may specify preferences over a network. In some embodiments, the service provider may notify the lender or servicer of any OA liens and/or determined actions and provide any recommendations based on the analysis discuss above.

Next, in some embodiments, the contacts module 504 is configured to provide OA contact information for a requested property. The contact information can be used by interested parties, such as lenders or servicers, to determine the contact info for OAs managing any properties of interest. For instance, a lender may request the contact info for a property it is considering funding and may want to contact the OA to determine the OA amount for the property and whether there are any OA liens associated with the property. Generally, OA contact information is not available publicly. An advantage of one embodiment of the present invention is that OA contact information can be aggregated and provided to interested parties upon request. The contacts module 504 may communicate received property identification information to the application 42 and application 44 to determine OA contact information for the received property identification.

In some embodiments, the services module 505 is configured to provide services information associated with OAs. The services information can be used by interested parties, such as OAs, to determine what services are being provided by various OAs and what fees OAs are paying for the services. For instance, an OA may be interested in determining a list of vendors for maintaining a community clubhouse. The OA may desire to view a list of vendors providing such a service in the local region and the fees being paid by other OAs to those vendors. The services module 505 may be configured to sell the services information in a report directly for example using a web interface. The report may include any services information desired including services, service fees, services types, services vendors, services vendors contact information, etc. In some embodiments, different subsets of the services information may be provided based on a tiered fees structure. In various embodiments, the services module 505 may receive services request information, such as a geographic region, type of service, type of vendor, etc. and communicate received services information to the application 42 and application 44 to determine the services information associated with the request. For example, an OA may request a list of swimming pool maintenance vendors in a particular zip code. The services module 505 may then communicate with the application 42 and 44 to determine the list of vendors associated with OAs in the requested zip code that perform swimming pool maintenance and provide the information to the requesting entity.

Next, in some embodiments, the trends module 506 may communicate with applications 42 and 44 and use one or more trained OAMs to produce an OAM amount and an error level (e.g., confidence score) for one or more subject properties over a period of time to identify trends. The outputs of the OA Amounts Prediction Module 203, Estimation Module 204, and/or Error Prediction Module 205, may be collected and stored at a periodic frequency to identify trends in OA amounts. For example, in some embodiments, OA amounts found by the OA Amounts Prediction Module 203 and/or application 44 may be collected and stored every month to generate an OA Amounts trends table that can be stored or provided to interested parties such as the computing device 26. In some embodiments, the OA Amounts trends table may provide the identified OA amounts in any format that is desired. For example, an OA Amounts table that provides an average OA amount by geographic area and property type (e.g., single family detached/condo/unit in multi-family complex, etc.) can be provided. Other dimensions could include (but not limited to) OA status (e.g., HOA, condo, co-operative), location (e.g., zip code, school district, geographic area characteristics of interest, etc.), property attributes (e.g., bedrooms, year built, number of floors, etc.). In various embodiments, OA amounts trends may be provided as an index. The index can be used to show the collective level of OA amounts and trends in a dimension of interest. For instance, the index can represent the collective level (e.g., average, weighted average, etc.) of OA amounts in a particular zip code. As another example, the index could represent the collective level of OA amounts for three-bedroom houses managed by a particular OA.

In some embodiments, OA trends may be used to forecast which OA fees will change in the future. For example, OA fees overall may rise and fall together based on factors including inflation, legislative action, technological change, and other factors. For instance increased reserve requirements or decreased insurance costs due to industry efficiency, or a change in the services typically provided by the association may affect OA fees over time. In one embodiment, these increases and decreases in overall market fees are not predicted, but the change in each OA fee relative to the overall population is predicted. That is, embodiments of the present invention may predict that the fees for a particular OA are likely to rise soon relative to the fees of all other OAs. Predictive models, as discussed above, may be generated to predict the changes in OA fees. Some example attributes that may be considered by the predictive model may include but not limited to the difference between the inferred OA fee and the predicted OA fee discussed above, the length of time that has passed since the last OA fee change, the fraction of OAs in the region of the OA that have changed their fees during the past one year, during the past two years, etc.

In one embodiment, separate regression models may be built that predict how much the OA fee will increase (decrease) relative to the overall population within the next one year, within the next two years, within the next five years. In an alternative embodiment, separate models may be built that predict whether the OA fee will change and, if so, by how much the OA fee will change relative to the overall population.

### Example Real Estate OA Amount Determination Process

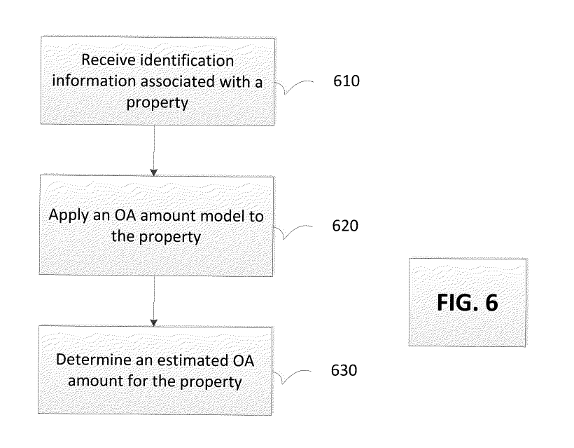

FIG. 6 illustrates one embodiment of an automated process that may be used by the analytics applications 22 to determine an OA amount for a subject property. As mentioned above, this process may be useful (as one example) for enabling an investor to decide whether to invest in a subject property.

As depicted by block 610 of FIG. 6, the application 44 initially receives identification information associated with a property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-34 or any other data repository to map the received identification information to the subject property.

As depicted by block 620 of FIG. 6, OAMs can execute a model for the property and outputs an OA amount estimation for the property (block 630). The outputs of the OAM may be collected by application 46 to identify any OA amounts and may store or provide the estimated values to interested parties, such as the computing device 26. In some embodiments a confidence or expected error metric may also be determined.

### Example Real Estate OA Rating Determination Process

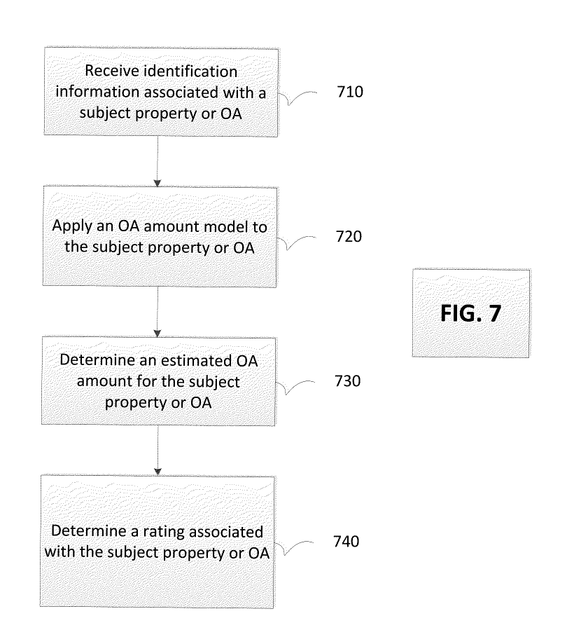

FIG. 7 illustrates one embodiment of an automated process that may be used by the analytics applications 22 to determine a rating/ranking for a subject property or OA. As mentioned above, this process may be useful (as one example) for enabling an OA, investor, financial institution, etc. to determine how the OA amount for a particular property/OA or group of properties/OAs compares to OA amounts for other properties/OAs.

As depicted by block 710 of FIG. 7, the application 46 initially receives identification information associated with a property (e.g., address, property owner identification, parcel number, etc.) or an OA. Application 46 may communicate with computing device 26 to receive the identification information. The application 46 may then, in some embodiments, process the received identification information to uniquely identify the subject property or OA of interest by, for example, communicating with data repositories 30-34 or any other data repository to map the received identification information to the subject property or OA.

As depicted by blocks 720 of FIG. 7, the trained OAMs can execute the model for the property using derived variables and outputs an OA amount prediction for the property (block 730). For the subject OA, the trained OAMs can execute the model for each property managed by the OA and outputs an OA amount prediction for each property managed by the subject OA. The outputs of the generated OAM may be collected by application 46 to identify any OA amounts for the property or OA.

As depicted by block 740 of FIG. 7, application 46 may determine a rating/ranking associated with the subject property or OA based on the predicted OA amounts. Application 46 may compare the predicted OA amounts with the actual or inferred OA amounts for the subject property or properties managed by the subject OA and determine a ranking/rating. The comparisons may be combined to determine a ranking/rating for the OA of interest using the processes discussed above. Application 46 may store or provide the ratings/rankings to interested parties, such as the computing device 26. As explained, in some embodiments, a rating/ranking can be determined by considering a variety of other factors. For example, the ratings/rankings may be based on number of services/amenities provided by the OA in comparison to other OAs, OA amounts charged by the OA in combination with the number of services in comparison to other OAs, quality of services providers used by the OA in comparison to other OAs, type of services provided by the OA in comparison to others OAs, fees paid for services by the OA in comparison to others, etc. A combination of these factors among others may be considered in determination of the rankings/ratings using the processes discussed above. As also discussed above, in some embodiments, the rankings/ratings may be determined based on user preferences.

### Example Real Estate OA Recommendation Process

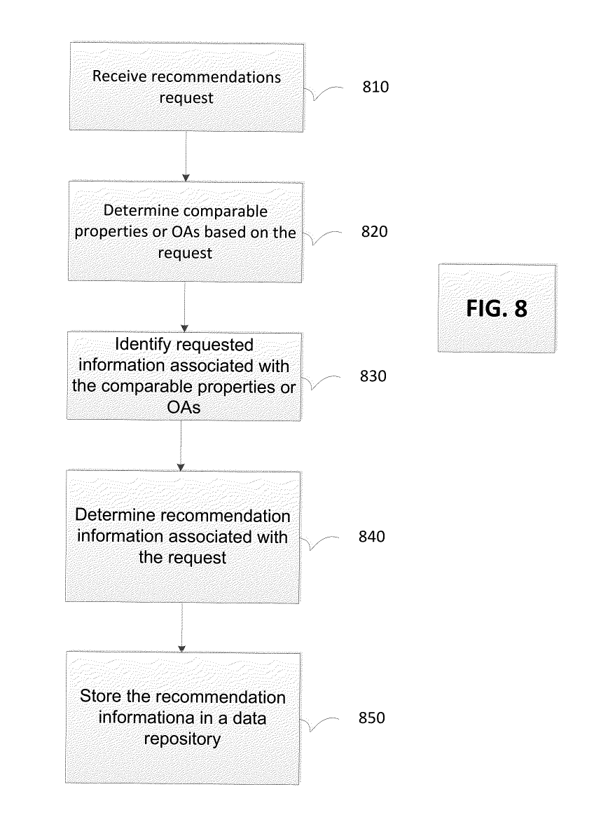

FIG. 8 illustrates one embodiment of an automated process that may be used by the analytics applications 22 to provide a recommendation for an OA amount and/or OA information for a property or group of properties or for an OA or group of OAs. As mentioned above, this process may be useful (as one example) for enabling an OA to determine how much fees should be charged by the OA.

As depicted by block 810 of FIG. 8, the application 46 initially receives a recommendations request. As explained above, the recommendations request may include any type of information desired that may be used by application 46 to provide the requested recommendation. For example, the recommendations request may include property characteristics, OA attributes, location characteristics, timing characteristics, etc. for a new development with a request for a recommended OA amount, a desired OA amount with a request for services or property characteristics, a desired vendors services fees with a request for recommended vendors, property characteristics for properties of interest and a desired return on investment with a request for a recommended OA amount, etc. A variety of other types of requests and information may be provided to application 46. Application 46 may communicate with computing device 26 to receive the identification information.

As shown in block 820 of FIG. 8, application 46 then may process the recommendations request by determining comparable properties or OAs based on the recommendations request. For example, application 46 may determine the comparable properties or OAs for the requested new development, the comparable OAs based on the desired OA amount, the comparable properties or OAs and associated vendors for the desired vendor's services fees, the comparable properties or OAs for the requested properties of interest and desired return on investment, etc.

As depicted by blocks 830 of FIG. 8, the requested information is identified associated with the determined comparable properties. For example, application 46 may identify property characteristics and OA amounts for the comparable properties or OAs for the requested new development, OA amounts for the comparable OAs based on the desired OA amount, vendors and services fees for the comparable properties or OAs for the desired vendors services fees, OA amounts and property characteristics for the comparable properties or OAs and desired return on investment, etc.

As depicted by block 840 of FIG. 8, application 46 may determine recommended information based on the identified information. As explained, in some embodiments, application 46 may provide the identified information as the recommendations information. For example, application may provide a list of vendors as the recommendations information. In other embodiments, application 46 may determine the recommendation information by combining the identified information using any of the processes discussed above. For example, application 46 may determine a recommended OA amount for the new development by averaging the OA amounts identified for the comparable properties or OA. Subsequently, as depicted by block 650 of FIG. 6, the determined recommendations information may be stored in a data repository. In some embodiments, the determined recommendations information may be provided to computing device 26.

### Example Real Estate OA Liens Process

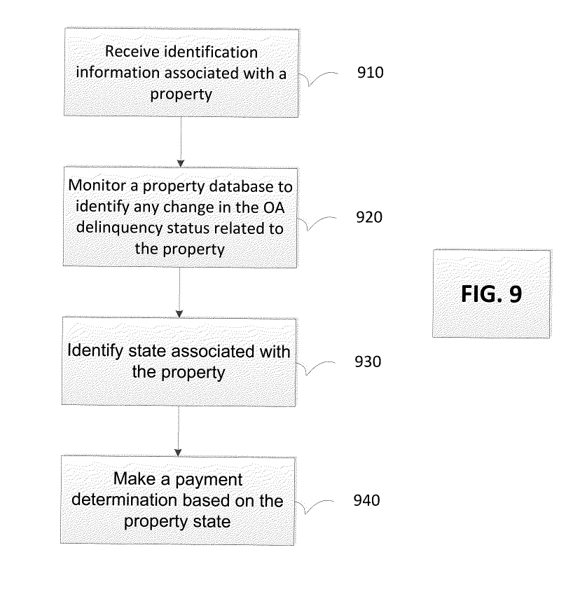

FIG. 9 illustrates one embodiment of an automated process that may be used by the analytics applications 22 to identify any OA liens associated with properties and determine an action associated with any identified liens. This process may be useful (as one example) for enabling lenders to protect their interests in real estate properties.

As depicted by block 910 of FIG. 9, the application 46 initially receives identification information associated with a property (e.g., address, property owner identification, parcel number, etc.). Application 46 may communicate with computing device 26 to receive the identification information. The application 46 may then, in some embodiments, process the received identification information to uniquely identify the subject property, for example, by communicating with data repositories 30-34 or any other data repository to map the received identification information to the subject property.

As shown in block 920 of FIG. 9, application 46 then may monitor a property database to identify any change in the OA delinquency status related to the property. Application 46 may monitor data repositories 30-34 to identify any OA liens that have been recorded or referenced associated with the property.

As depicted by blocks 930 of FIG. 9, for any identified OA liens, application 46 may identify a state associated with the identified liens. As explained, a priority associated with any identified liens can be identified and used to make a determination of an action.

As depicted by block 940 of FIG. 9, application 46 may make a payment determination based on the property state. As explained, the payment determination may be based on a variety of factors. For example, the payment determination may be based on a set of business rules or equity analysis. In some embodiments, the factors may be customizable for each requesting party, such as lenders or servicers.

### Example Real Estate OA Contacts Process

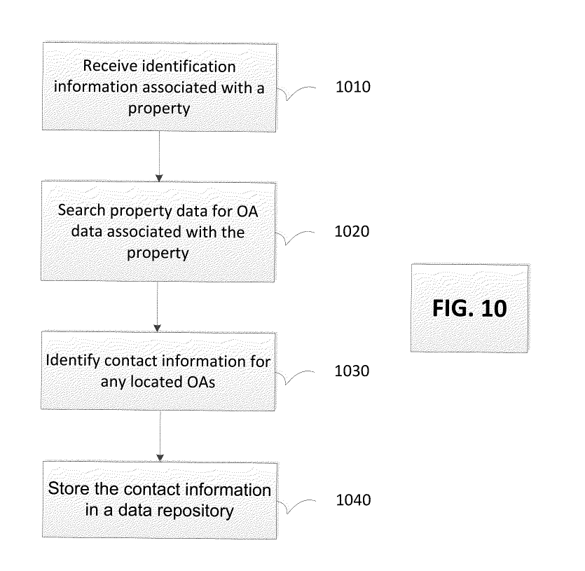

FIG. 10 illustrates one embodiment of an automated process that may be used by the analytics applications 22 to provide OA contact information for a requested property. This process may be useful (as one example) for enabling lenders to determine the contact info for OAs managing any properties of interest.

As depicted by block 1010 of FIG. 10, the application 46 initially receives identification information associated with a property (e.g., address, property owner identification, parcel number, etc.). Application 46 may communicate with computing device 26 to receive the identification information. The application 46 may then, in some embodiments, process the received identification information to uniquely identify the subject property, for example, by communicating with data repositories 30-34 or any other data repository to map the received identification information to the subject property.

As shown in block 1020 of FIG. 10, application 46 then may search property data to identify any OA data associated with the property. Application 46 may search data repositories 30-34 to identify any OAs that are managing the property.

As depicted by blocks 1030 of FIG. 10, for any identified OAs, application 46 may identify contact information associated with the identified OAs. Application 46 may identify the contact information by accessing data repositories 30-34. Subsequently, as depicted by block 1040 of FIG. 10, the identified contacts information may be stored in a data repository. In some embodiments, the determined contacts information may be provided to computing device 26.

### Example Real Estate OA Trends Process

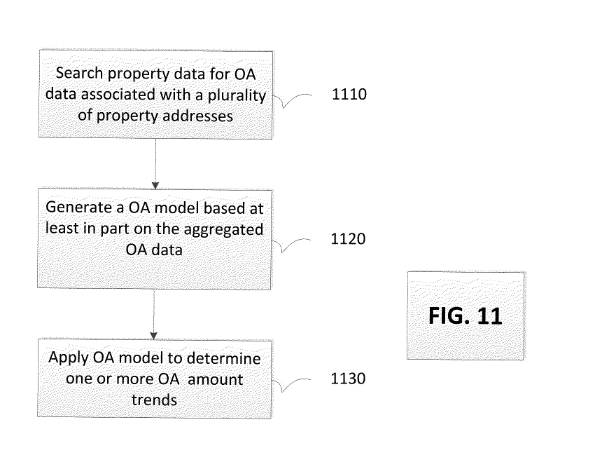

FIG. 11 illustrates one embodiment of an automated process that may be used by the analytics applications 22 to produce an OA amount and an error level (e.g., confidence score) for one or more subject properties over a period of time to identify trends. This process may be useful (as one example) for enabling an investor to decide whether to invest in a subject property.

As depicted by block 1110 of FIG. 11, the application 46 initially searches property data for OA data associated with a plurality of property addresses. As discussed above, application 46 may communicate with data repositories 30-34 to identify all OA data associated with the properties.

Subsequently, as depicted by block 1120 of FIG. 11, a OA amount model may be generated based at least in part on the identified OA data. As explained above, the application 44 may build the OA amount model to infer or predict OA amounts. In some embodiments, an error model may also be generated as also discussed above.

As depicted by blocks 1130 of FIG. 11, the outputs of the generated OA amount model may be collected by application 46 to identify any OA amount trends. As explained above, the application 46 may collect OA amount outputs from the generated OA amount model at periodic intervals to identify OA amount trends. The identified OA amount trends may be stored or provided to interested parties, such as the computing device 26.

### Example Real Estate Valuation Determination Process

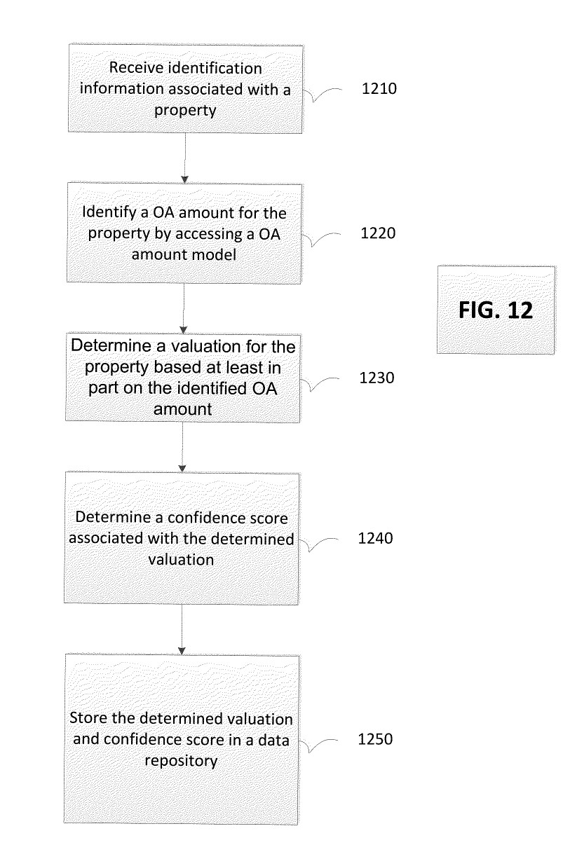

FIG. 12 illustrates one embodiment of an automated process that may be used by the analytics applications 22 to identify an automated valuation for real estate properties based in part on any identified OA amounts for the real estate properties. As mentioned above, this process may be useful (as one example) for enabling an investor to decide how much a property is worth based on a subject property's OA amount.

As depicted by block 1210 of FIG. 12, the application 48 initially receives identification information associated with a property (e.g., address, property owner identification, parcel number, etc.). Application 48 may communicate with computing device 26 to receive the identification information. The application 48 may then, in some embodiments, process the received identification information to uniquely identify the subject property of interest by, for example, communicating with data repositories 30-34 or any other data repository to map the received identification information to the subject property.

As shown in block 1220 of FIG. 12, the application 48 then identifies an OA amount or trend associated with the property by accessing an OA amount model. As discussed above, application 48 may communicate with application 44 to identify any OA amounts or trends for the property based on the OA amount model that was generated by application 44.

Subsequently, as depicted by blocks 1230 of FIG. 12, a valuation for the property based at least in part on the identified OA amount or trend may be identified. As explained above, an automated valuation model, such as a regression model, a neural network model, etc., may be generated using the identified OA amount or trend as an input along with any other desired inputs and an automated valuation as an output for the automated valuation model may be determined.

As depicted by blocks 1240 of FIG. 12, a confidence score associated with the determined automated valuation may be determined. As explained above, the application 48 may generate an error model associated with the automated valuation determinations. The outputs from the error model may be identified and a confidence score determined. As depicted by block 1250 of FIG. 12, the determined valuation and confidence score may be stored in a data repository. In some embodiments, the determined valuation and confidence score may be provided to computing device 26.

### Example Real Estate Investment Metric Determination Process

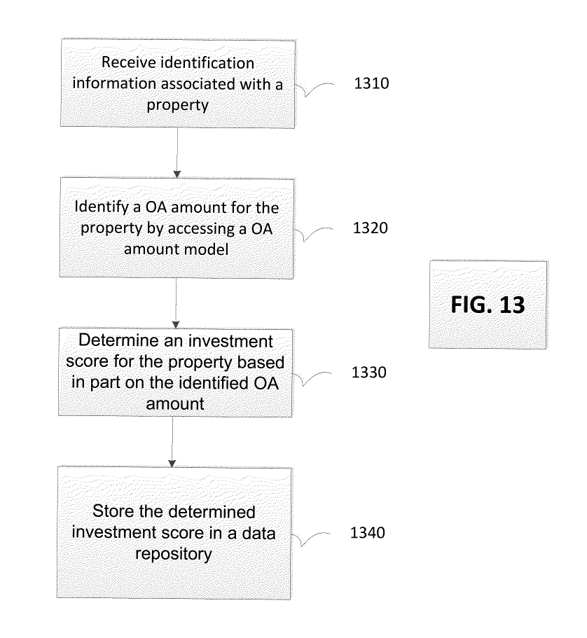

FIG. 13 illustrates one embodiment of an automated process that may be used by the analytics applications 22 to identify an investment metric for real estate properties based in part on any identified OA amounts for the real estate properties. The example in FIG. 13 relates to calculation of an investment score. An investment score can provide a ranking that quantifies the investment, opportunity and risk in a property. However, one skilled in the art will realize that the investment score is representative, and similar metrics may also be calculated based in part on the identified OA amounts. In this manner, investment metrics, including capitalization rate, expected cash flow, predicted future price appreciation, a risk score, default score, and the like may be calculated based in part on the identified OA amounts. As mentioned above, this process may be useful (as one example) for enabling an investor to decide whether to purchase a property or set of properties, a lender to decide whether to provide a loan for a subject property.

One use case is determining homeowners association fees that may be substantially reduced. This situation can arise because the homeowners association or the contract management company is inefficient or because a substantial fraction of the fees are captured by the management company as profit. This may be particularly applicable to timeshare associations as well as other types of owners associations. For example, suppose that an investor is willing to purchase properties with a 5% capitalization rate. Each townhouse in a particular homeowners association has a $600 per month homeowners association fee. Replacing the management company with a different company willing to provide the same services for $300 per month can reduce the operating expense by $3600 per year per unit. Based on the 5% capitalization rate, this reduction in homeowners association fee may increase the value of each property by $72,000. Thus, an investor who purchases a substantial number of units and changes the management company by a vote of the owners would may obtain a substantially higher rate of return on their rental investments and/or see substantial capital appreciation due to the lowered cost of ownership.

As depicted by block 1310 of FIG. 13, the application 48 initially receives identification information associated with a property (e.g., address, property owner identification, parcel number, etc.). Application 48 may communicate with computing device 26 to receive the identification information. The application 48 may then, in some embodiments, process the received identification information to uniquely identify the subject property of interest by, for example, communicating with data repositories 30-34 or any other data repository to map the received identification information to the subject property.

As shown in block 1320 of FIG. 13, the application 48 then identifies an OA amount or trend associated with the property by accessing an OA amount model. As discussed above, application 48 may communicate with application 42 to identify any OA amounts or trends for the property based on the OA amount model that was generated by application 44.

Subsequently, as depicted by blocks 1330 of FIG. 13, an investment score for the property based at least in part on the identified OA amount or trend may be identified. As explained above, an investment score model, such as a regression model, a neural network model, etc., may be generated using the identified OA amount or trend as an input along with any other desired inputs and an investment score as an output for the investment model may be determined. The determined investment score may be stored in a data repository (block 1340) or may be provided to computing device 26.

### Conclusion

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as the region determination 201, OA amounts analysis module 201, OA amounts prediction module 203, estimation 204, and error prediction module 205, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as relational databases and flat file systems that use magnetic disk storage and/or solid state RAM. Some or all of the components shown in FIG. 1, such as those that are part of the Analytics System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A non-transitory computer readable storage medium comprising instructions which, when executed by a computer system that includes a data processor and is connected to at least one data repository, perform a method comprising:
(a) accessing, by the computer system from the at least one data repository through a communication channel, owner association (OA) data associated with a plurality of real estate properties;
(b) generating, by the data processor of the computer system, an OA amount model based at least in part on the accessed OA data associated with the plurality of real estate properties, wherein the generating comprises:
assigning each property in a geographic area to a group based at least in part on a location of each property;
iteratively merging pairs of geospatially adjacent groups if the characteristics of assigned properties in the geospatially adjacent groups are adequately similar; and
iteratively inferring an OA amount for each property in the geographic area by inferring an OA amount for each property in a respective merged pair of geospatially adjacent groups for which OA amount is not known based at least in part on an OA amount for a property in the same group for which the OA amount is known;
(c) receiving, by the computer system through a network communication channel, identification information associated with a subject property;
(d) determining, by the data processor of the computer system, an estimated OA amount for the subject property by applying the OA amount model to the property; and
(e) storing, by the data processor of the computer system through the communication channel, the estimated OA amount in the at least one data repository.

2. The non-transitory computer readable storage medium of claim 1, where the method further comprises identifying one or more confidence scores associated with the estimated OA amount.

3. The non-transitory computer readable storage medium of claim 1, wherein each property in the geographic area is assigned to a group based at least in part on a location and property characteristics of each property.

4. The non-transitory computer readable storage medium of claim 1, wherein the data repository comprises an electronic database.

5. The non-transitory computer readable storage medium of claim 1, wherein the method further comprises providing the estimated OA amount via a web interface.

6. The non-transitory computer readable storage medium of claim 1, wherein the OA amount comprises a homeowners association monthly fee.

7. A system comprising:
physical data storage configured to store (1) OA data associated with real estate properties and (2) recommendations associated with the real estate properties; and
a computer system in communication with the physical data storage, the computer system comprising computer hardware, the computer system programed to:
receive, by the computer system over a network communication channel, identification information associated with a subject owner association (OA);
identify, by the computer system, one or more comparable OAs;
determine, by the computer system, OA amounts associated with the one or more comparable OAs and the subject OA by accessing an OA amount model;
determine a rating for the subject OA by comparing the OA amounts associated with the one or more comparable OAs and the OA amount associated with the subject OA; and
store the determined rating in the physical data storage.

8. The system of claim 7, wherein the OA comprises a homeowners association.

9. The system of claim 7, wherein the comparing comprises comparing an average of the OA amounts associated with the one or more comparable OAs with the OA amount associated with the subject OA.

10. The system of claim 7, wherein the comparing comprises comparing a weighted average of the OA amounts associated with the one or more comparable OAs with the OA amount associated with the subject OA.

11. The system of claim 7, wherein the comparable OAs are determined by comparing property characteristics of properties managed by OAs with the property characteristics of the properties managed by the subject OA.

12. The system of claim 7, wherein the system is further programmed to receive user preferences and determine the rating based at least in part on the user preferences.

13. The system of claim 7, wherein the computer system is further programmed to provide the determined rating via a web interface.

14. The system of claim 7, wherein the physical data storage comprises an electronic database.

15. A non-transitory computer readable storage medium comprising instructions which, when executed by a computer system that includes a data processor and is connected to at least one data repository, perform a method comprising:
(a) receiving, by the computer system through a network communication channel, identification information associated with a plurality of properties associated with an owner association (OA);
(b) determining, by the processor of the computer system, an estimated OA amount for each property of the plurality of properties by applying an OA amount model to each property;
(c); storing, by the data processor of the computer system through the communication channel, the estimated OA amount for each property of the plurality of properties in the at least one data repository
(d) providing, by the data processor of the computer system through the network communication channel, a report comprising the estimated OA amount for each property of the plurality of properties.

16. The non-transitory computer readable storage medium of claim 15, wherein the OA amount model comprises a group determination model that assigns each of the plurality of properties to a group based on respective property characteristics and determining the estimated OA amount for each property based at least in part on the respective assigned group.

17. The non-transitory computer readable storage medium of claim 15, wherein the OA amount model comprises a regression model.

18. The non-transitory computer readable storage medium of claim 16, wherein the report is organized by property type.

19. The non-transitory computer readable storage medium of claim 15, wherein the report is provided via a web interface.

20. The non-transitory computer readable storage medium of claim 15, wherein the data repository comprises an electronic database.
